(19) United States
(12) Patent Application Publication
(10) Pub. No.: US 2017/0095693 A1
(43) Pub. Date: Apr. 6, 2017

(54) SYSTEM AND METHOD FOR A WEARABLE TECHNOLOGY PLATFORM

(71) Applicant: Lumo BodyTech, Inc, Mountain View, CA (US)

(72) Inventors: Andrew Robert Chang, Sunnyvale, CA (US); Andreas Martin Hauenstein, San Mateo, CA (US); Supriya Kher, Mountain View, CA (US); Dennis William Bohm, Mountain View, CA (US)

(21) Appl. No.: 15/284,256

(22) Filed: Oct. 3, 2016

Related U.S. Application Data
(60) Provisional application No. 62/236,458, filed on Oct. 2, 2015.
(60) Provisional application No. 62/305,883, filed on Mar. 9, 2016.

(51) Int. Cl. A63B 24/00; G09B 5/02

(52) U.S. Cl. CPC A63B 24/0062; G09B 5/02; A63B 2220/00; H04W 4/008

(57) ABSTRACT

A system and method for customizing biomechanical wearable sensors can include a customizable biomechanical processing layer, activity model layer, and/or device communication and processing management. The system and method can include monitoring biomechanical signals at a first set of wearable sensors configured in an initial biomechanical processing configuration; selecting a configuration option for the first set of wearable sensors; delivering the configuration option to the at least one wearable sensor; and monitoring biomechanical signals according to an altered biomechanical processing configuration that is altered according to the configuration option.

### CROSS-REFERENCE TO RELATED APPLICATIONS

This application claims the benefit of U.S. Provisional Application No. 62/236,458, filed on 2 Oct. 2015, and U.S. Provisional Application No. 62/305,883, filed on 9 Mar. 2016, both of which are incorporated in their entireties by this reference.

### TECHNICAL FIELD

This invention relates generally to the field of activity tracking, and more specifically to a new and useful system and method for a wearable technology platform.

### BACKGROUND

In recent years, numerous players have entered the wearable technology space. However, providing a compelling product can be challenging because of the diverse set of infrastructure to support wearable technology. Product integration into clothing and accessories needs to be compelling to consumers from a fashion and functional standpoint. Entities with specialization in clothing and product manufacturing looking to enter the wearable technology space lack resources to build out supporting software and hardware. The data produced by a wearable product has to provide at least some baseline functionality to be enticing to users. Many products in today's market provide rudimentary feedback and analysis tools such as generic activity tracking and/or basic step counting. Software companies and/or hardware companies may similarly lack channels to productize technology or adapt technology to provide substantial health benefits. Similarly, doctors, sports health specialists, and researchers lack tools to efficiently research issues relating to different activities or to put research into active use. Thus, there is a need in the activity-tracking field to create a new and useful system and method for a wearable technology platform. This invention provides such a new and useful system and method.

### BRIEF DESCRIPTION OF THE FIGURES

FIG. 1 is a schematic representation of the system of a preferred embodiment;

FIG. 2 is a schematic representation of multiple use-case integrations serving distinct products and use-cases;

FIGS. 3A-3C are schematic representations of system architecture variations;

FIG. 4 is a flowchart representation of a method of a preferred embodiment;

FIG. 5 is a flowchart representation of a method for programmatically customizing biomechanical sensing;

FIGS. 6 and 7 are schematic representations of variations of selecting a configuration option;

FIGS. 8-10 are schematic representations of variations of receiving a processing alteration event;

FIG. 11 is a schematic representation of a variation of analyzing data of at least one wearable sensor;

FIG. 12 is a schematic representation of a variation that selects a preferred configuration option;

FIG. 13 is a schematic representation of a variation used when synchronizing different user applications;

FIG. 14 is a flowchart representation of a data streaming method;

FIG. 15A is a graphical representation of a control packet;

FIG. 15B is a graphical representation of a data packet; and

FIG. 16 is a flowchart representation of a data streaming method applied to asynchronous notifications.

### DESCRIPTION OF THE EMBODIMENTS

The following description of the embodiments of the invention is not intended to limit the invention to these embodiments but rather to enable a person skilled in the art to make and use this invention.

### 1. System for a Wearable Technology Platform

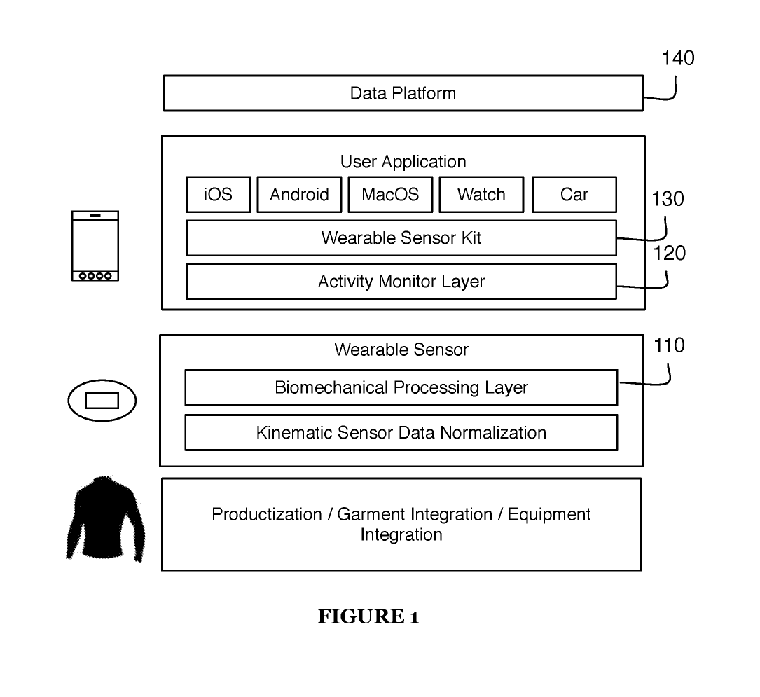

As shown in FIG. 1, a system for a wearable technology platform of a preferred embodiment includes a biomechanical processing layer 110, an activity model layer 120, a device communication and processing management system 130, and a data platform 140. The system can additionally include or be operable with at least one type of wearable sensor. The system functions to provide a Platform as a Service (PaaS) technology stack to support wearable technology products. Through integration with the system, a developer can leverage existing technology layers and the framework of the system to produce a wearable technology product. A developer could be a garment manufacturer, a sensor/consumer electronic manufacturer, a researcher in the biomechanics space, an application developer, a data analytic specialist, or any suitable entity. The system can enable integration, configuration, and/or controllability at one or more different layers. A developer may be able to build a use-case integration at different layers depending on the core competency of the developer. A use-case integration can describe one product offering using the wearable technology platform. For example, an entity may configure an activity monitor device that interacts with a smart phone application for providing activity tracking and feedback—the entity will develop a use-case integration with the platform to support such functionality. The system preferably alleviates or simplifies the process of building out a full technology stack to support wearable technology. In this way, products can be developed faster for more diverse use-cases. For example, a garment manufacturer may be alleviated from building sensing technology, understanding the sensed activity, and/or distributing a mobile application. These aspects can be provided through the system. Similarly, a mobile app developer may be able to build a compelling software product without dealing with manufacturing a physical wearable sensor. A developed app may be compatible with a set of wearable sensing devices on the market.

In one preferred implementation, the system is used to allow controlled management of the biomechanical sensing processes across a plurality of activity monitoring devices. Activity process configuration within a wearable sensor can be remotely managed from the cloud such that wearable sensors connected to the system can be updated and/or customized. In one application, customized approaches for sensing biomechanical information of an activity could be customized for individuals or across groups of users. Additionally, various technology partners may be able integrate with the system and benefit from customized and adjustable sensing approaches within their products.

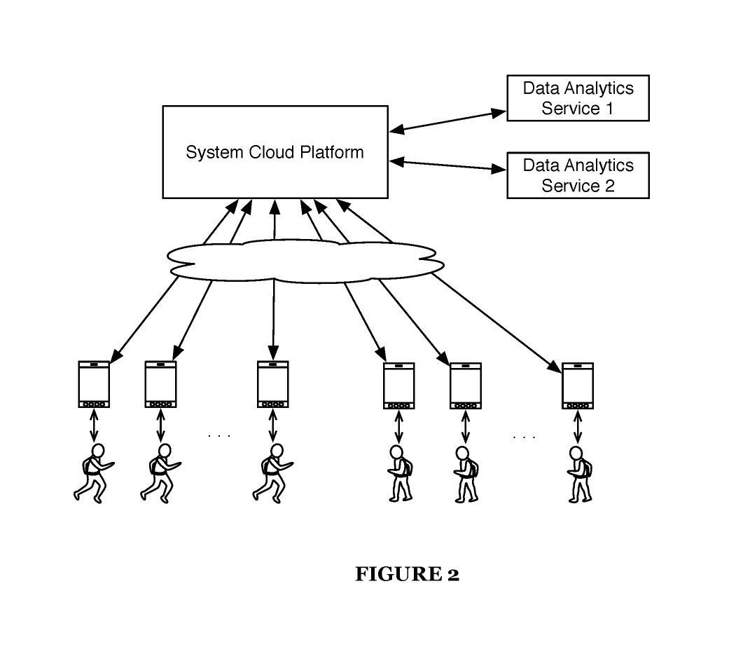

The system is preferably distributed between a network accessible platform service and device instances with various aspects of system integration. Preferably, once a developer builds a use-case integration and configures how the system is used with the integration, a plurality of different device instances can use the system as shown in FIG. 2.

The system is preferably directed at wearable technology focusing on activity tracking. Tracked activities can include sports, exercise, medical rehabilitation, ergonomics, and/or any suitable space dealing with the biomechanical aspects of a participant's actions. In particular, the system can provide various platform mechanisms to support advanced biomechanical interpretation and modeling capabilities. Additionally or alternatively, the system can be used in providing biomechanical, kinematic, and/or orientation information for a variety of products. The system may be integrated with clothing such as a shorts, pants, undergarments, a shirt, shoes; an accessory such as a watch, eyeglasses, headphones, jewelry, a hat; a product such as a phone, a phone case, keys, toys, sporting equipment, internet of things (IoT) devices; and/or any suitable object.

The system can be a multitenant system wherein multiple developer entities can use the system in providing infrastructure for a wearable technology product. A product developer can create an account and begin building a use-case integration with the system. The use-case integration describes how a product developer uses the system. The use-case integration may be used in a product offering of the developer, which may be used by a plurality of end users. For example, a sports apparel company may want to use the wearable sensor technology and the biomechanical processing layer 110 of the system in their own products. The system can support them registering and managing wearable sensors used in their products by, for example, changing the biomechanical processing configuration (i.e., the processes used to generate a biomechanical signal) or an activity model (i.e., the logic for how biomechanical signals are interpreted by an application).

In one variation, sub-components of a use-case integration may be compatible with other use-case integrations, which functions to enable cross compatibility between technology layers of different developers. For example, sensor module of one developer may be compatible with an end-user application of another developer. Through the contribution of multiple developers there may be a suite of options for wearable sensing devices, biomechanical processing configurations, activity models, user applications, data analysis and management products, and/or other suitable products. For example, a product developer for a particular wearable sensor may select from a number of different activity models and mobile applications that can be used with the wearable sensor.

Alternatively, all or part of the system can be managed and controlled so that only selected participants can gain access to the system. In one variation, the system may be an internal system used by a single entity, and used to provide flexibility in building out various products and technologies in the wearable sensor space.

The system may additionally include a set of wearable sensors. A wearable sensor of a preferred embodiment functions to track motion and activity of at least one participant. Preferably, the participant is a human, but the participant may alternatively be any suitable animal or device capable of locomotion. The wearable sensor is preferably substantially coupled to a static location of the participant. In a preferred embodiment, the wearable sensor is physically coupled in the waist region of a participant, and more specifically, the wearable sensor is physically coupled in the lumbar sacral region of the back in the waistband of a garment. In one implementation the wearable sensor is integrated into a waistband of shorts, pants, or a belt. A wearable sensor can alternatively be positioned in the mid-back, upper-back, neck region, shoulders, feet, wrists, or any suitable location. In some variations, the wearable sensor is directly integrated into another product.

The wearable sensor device may include at least a subset of standardized components. The standardized components could include a standardized data format, communication protocol, and/or sensing mechanism. A standardized component functions to provide a mechanism on top of which other developers can build customized wearable sensor devices. For example, a set of standardized inertial measuring unit sensors may have been validated and calibrated for use with the biomechanical processing layer 110. In another example, a standardized sensor library can be included in a wearable sensor device. The sensor library can provide a custom interface for building a wearable sensor device that is compatible with the system and handles multiple aspects such as sensor data processing (i.e., the biomechanical processing configuration), application logic, and communication logic for communication with a secondary device such as a smart phone. More preferably, the wearable sensor device includes dynamically controlled biomechanical processing configuration that is managed through the data platform. The biomechanical processing configuration can define the processes used in the biomechanical processing layer no. In one variation, partners that use compatible wearable sensor devices can allow the algorithms and sensing processes to be managed and controlled through the data platform. Remote control of the biomechanical processing layer 110 can enable various control features. For example, group data analytics and sensing improvements may be distributed back to the compatible wearable sensor devices.

The wearable sensor device can include an inertial measurement unit (IMU). The IMU preferably includes a set of sensors aligned for detection of kinematic properties along three perpendicular axes. An IMU can include at least one accelerometer, gyroscope, magnetometer, or other suitable inertial sensor. In one variation, the IMU is a 9-axis motion-tracking device that includes a 3-axis gyroscope, a 3-axis accelerometer, and a 3-axis magnetometer. The wearable sensor device can additionally include an integrated processor that provides sensor fusion in hardware, which effectively provides a separation of forces caused by gravity from forces caused by speed changes on the sensor. The on-device sensor fusion may provide other suitable sensor conveniences. Alternatively, multiple distinct sensors can be combined to provide a set of kinematic measurements.

In one preferred embodiment, the system can support activity monitoring that employs multiple wearable sensors. Multiple wearable sensors can be combined to provide multiple points of activity sensing. In a first variation, a set of wearable sensors can include a waist sensing device and two ankle sensing devices. The configuration and setup of the wearable sensor may be determined and customized by a developer entity using the system. For example, a running application may configure its integration with the system to use three sensors, and a walking application may configure its integration with the system to use a single sensor.

The biomechanical processing layer no of a preferred embodiment functions to transform sensor data into a set of biomechanical signals. A biomechanical signal preferably parameterizes a biomechanical-based property of some action. More particularly biomechanical signal quantifies at least one aspect of motion that occurs once or repeatedly during a task. For example, in the case of walking or running, how a participant takes each step can be broken into several biomechanical signals. In a preferred implementation, the system and method preferably operate with a set of biomechanical signals that can include cadence, ground contact time, braking, pelvic rotation, pelvic tilt, pelvic drop, vertical oscillation of the pelvis, forward oscillation, forward velocity properties of the pelvis, step duration, stride length, step impact, foot pronation, foot contact angle, foot impact, body loading ratio, foot lift, motion paths, and other running stride-based signals.

Cadence can be characterized as the step rate of the participant.

Ground contact time is a measure of how long a foot is in contact with the ground during a step. The ground contact time can be a time duration, a percent or ratio of ground contact compared to the step duration, a comparison of right and left ground contact time or any suitable characterization.

Braking or the intra-step change is the deceleration in the direction of motion that occurs on ground contact. Braking can be the difference between the minimal velocity point and the average difference between the maximum and minimum velocity. A step impact signal may be a characterization of the timing and/or properties relating to the dynamics of a foot contacting the ground.

Pelvic dynamics can be represented in several different biomechanical signals including pelvic rotation, pelvic tilt, and pelvic drop. Pelvic rotation (i.e., yaw) can characterize the rotation about the transverse plane (i.e., rotation about a vertical axis). Pelvic tilt (i.e., pitch) can be characterized as rotation about a the sagittal plane (i.e., rotation about an axis in the forward/backward direction). Pelvic drop (i.e., roll) can be characterized as rotation about the coronal plane (i.e., rotation about the lateral axis).

Vertical oscillation of the pelvis is characterization of the up and down bounce during a step (e.g., the bounce of a step).

Forward velocity properties of the pelvis or the forward oscillation can be one or more signals characterizing the oscillation of distance over a step or stride, velocity, maximum velocity, minimum velocity, average velocity, or any suitable property of forward kinematic properties of the pelvis.

Step duration could be the amount of time to take one step. Stride duration could similarly be used, wherein a stride includes two consecutive steps.

Foot pronation could be a characterization of the angle of a foot during a stride or at some point of a stride. Similarly foot contact angle can be the amount of rotation in the foot on ground contact. Foot impact is the upward deceleration that is experienced occurring during ground contact. The body-loading ratio can be used in classifying heel strikers, midfoot, and forefoot strikers. The foot lift can be the vertical displacement of each foot. The motion path can be a position over time map for at least one point of the runner's body. The position is preferably measured relative to the athlete. The position can be measured in one, two, or three dimensions. As a feature, the motion path can be characterized by different parameters such as consistency, range of motion in various directions, and other suitable properties. In another variation, a motion path can be compared based on its shape.

Additionally, the biomechanical signals can include left/right detection, which may be applied for further categorizing or segmenting of biomechanical signals according to the current stride side.

Additional processes may be implemented in the biomechanical processing layer 110 for sensing context around an activity or other information communicated through the movement or orientation of the wearable sensor. In one variation, activity detection can dynamically classify an activity based on aspects of detected biomechanical signals, orientation, inactivity, and other aspects. For example, activity detection may be able to distinguish between sitting, standing, walking, running, playing a sport, driving, and/or any suitable type of activity. The lack of an activity could additionally be characterized including when and how a wearable sensor is not used. For example, the wearable sensor may be able to detect and characterize what happens to the wearable sensor or object when it is not being worn, the orientation of the product when not worn, the frequency of being picked up, moved, going through a washing machine cycle, etc.

The pelvis can be used as a preferred reference point walking, running, and other activities. The pelvis can have a strong correlation to lower body movements and can be more isolated from upper body movements such as turning of the head and swinging of the arms. The sensing point of the activity monitor device 100 is preferably centrally positioned near the median plane in the trunk portion of the body. Additional sensing points or alternative sensing points may be used. In one variation, the position and/or number of sensing points can be adjusted depending on the activity. The number of sensing points may be increased by increasing the number of inertial measurement systems 110 and/or the number of activity monitor devices 100. In one variation, multiple activity monitor devices can be used to enhance the detection of the set of biomechanical signals. In another variation, a first activity monitor device may be used to detect a first set of biomechanical signals, and a second activity monitor device may be used to detect a second set of biomechanical signals; and the first and second set of biomechanical signals are distinct sets. Multiple activity monitoring devices 100 preferably communicate wirelessly and cooperate in generating a set of biomechanical signals. Alternatively, a wired or wireless inertial measurement system may communicate kinematic data to a main activity monitor device for processing.

The set of biomechanical signals may form a primitive set of signals from which a wide variety of activities can be monitored and analyzed. For example, the system and method may be applied to activity use-cases such as walking, running, limping/rehabilitation, lifting, swimming, skiing, skating, biking, rowing, and/or any suitable activity. Alternatively, some activities may include additional or alternative biomechanical signals in the primitive set of biomechanical signals.

A wearable sensor could additionally be integrated into or attached to another product such as a garment; an accessory such as a watch, eyeglasses, headphones, jewelry, a hat; a product such as a phone, a phone case, keys; and/or any suitable object. The system may be used to integrated motion and activity intelligence into a variety or products. For example, if a wearable sensor is integrated into eyeglasses, the biomechanical and kinematic sensing capabilities of the biomechanical processing layer 110 can be applied to detect when the glasses are worn on the head, raised and resting unused above the eyes, sitting on a table, being cleaned, being adjusted, or being in any suitable state as well as detecting various biomechanical signals such as neck angle, movement cadence, and/or other biomechanical signals.

The biomechanical processing layer 110 is preferably communicatively coupled to the sensor output of a wearable sensing device. Preferably, the biomechanical processing layer 110 is part of the firmware or otherwise executed onboard the wearable sensing device. The biomechanical processing layer no may alternatively be implemented outside of the wearable sensor. As mentioned the biomechanical processing layer 110 may be set by a configuration of the wearable sensor. The particular configuration of the biomechanical processing layer 110 may be set to a default value. In another variation, the configuration of the biomechanical processing layer may be adjusted for a particular productization of the wearable sensor. For example, one product model may be intended for running while another product model may be for swimming. The various biomechanical processing configurations could additionally be targeted at different categories of users. For example, one running product model may be intended for beginner runners while another running product model may be intended for advanced runners. As described below, the biomechanical processing configuration can be changed and altered as well. In another variation, a wearable sensor may be interchangeable between different activities. A user application synchronized to the wearable sensor device may be used to determine the appropriate biomechanical processing configuration. The location of the worn wearable sensor could additionally determine the appropriate biomechanical processing configuration. A wearable sensing device at the waist may be used in generating a particular set of biomechanical signals using a first biomechanical processing configuration, and a wearable sensing device at the ankle may be used in generating a different set of biomechanical signals through a second biomechanical processing configuration. The biomechanical processing layer 110 can preferably output biomechanical signals for cadence, ground contact time, braking, pelvic rotation, pelvic tilt, pelvic drop, vertical oscillation of the pelvis, forward oscillation of the pelvis, forward velocity properties of the pelvis, step duration, stride length, step impact, foot pronation, foot contact angle, foot impact, body loading ratio, foot lift, motion paths, and/or other running/walking stride-based signals when the wearable sensing device is identified as a waist-located device. A wearable sensing device worn on the shoes or on the ankles may be identified and used to produce a set of distinct foot biomechanical signals which may include ankle flex range, foot angle, foot contact coverage, and/or other suitable biomechanical signals. Other sensor positions such as neck/head locations, mid or upper back, shoulders, wrists, or other suitable positions may have alternative biomechanical processing configurations. The biomechanical processing configurations could be provided by the system and/or managed by operators of the system. Alternatively, a developer may configure a customized biomechanical signal process or augment an existing biomechanical signal process by delivering a customized biomechanical processing configuration.

The activity model layer 120 of a preferred embodiment functions to apply application logic to the biomechanical signals of the biomechanical processing layer 110. Application logic is preferably defined in an activity model. The activity model can apply an interpretation to the biomechanical signals and trigger various actions within the system or externally. The system may provide a standardized approach to how a given activity model interfaces with an end application. In one implementation, activity models may interface with application code through a set of defined actions. For example, an application model may provide feedback to a user according to a series of notifications or events. The notifications or events can be classified as warnings, alerts, updates, encouragement, goal achievements, and/or other classifications. An activity model may be configured and implemented through an application programming interface (API), a software development kit (SDK), a library, or another suitable programmatic tool.

The activity model layer 120 can include a set of selectable activity models offered by the system. The selectable activity models may address walking, running, standing, lifting, swimming, skiing, skating, biking, and/or rowing for example. An activity model may additionally be targeted at particular qualities or goals of the user or other aspects. An activity model may be targeted at a particular age group, fitness level, gender, weight, medical condition, environment, or other suitable characteristic. Product-specific activity models may be used to such as an activity model for eyeglasses, toys, IoT devices, and/or other objects. A developer can preferably define or customize various aspects of the application logic used in a particular activity model. Alternatively, a fully customized activity model can be developed and used with the system. Multiple activity models can be developed for the same use-case. For example, two different research groups may develop two distinct activity models for running.

An activity model when activated for a use-case integration receives at least a subset of the biological signals; the biological signals are processed according to various heuristics; and events are triggered based on the heuristics. For example, an activity model may trigger notification to the user when one or more biological signals indicate improper running form. The activity model may operate within a wearable sensing device, a secondary device, and/or in the cloud. A use-case integration can switch between different activity models. Additionally, multiple activity models can be activated simultaneously. In one particular implementation, the system can include an activity detector model that can detect different activity modes such as when a user is sitting, standing, walking, running, sprinting, biking, and/or performing any suitable activity. The activity detector model can operate continuously and activate and deactivate activity models according to the detected activity mode.

The device communication and processing management system 130 of a preferred embodiment functions to coordinate processing and/or data communication. The technology stack can be distributed across multiple devices. All or a part may be performed within a wearable sensing device, an application on a secondary device, or a cloud platform. In one use-case instance, the system can be distributed across a wearable sensing device, an application of a secondary device, and/or a remote computing platform. For example, a runner may wear a pair of smart running pants with an embedded activity sensor; the activity sensor communicates with a smart phone of the runner; and an application on the smart phone may communicate to an activity platform in the cloud. The device communication and processing management system can enable data to be communicated between devices. Sensor data, biomechanical data, activity model event, and/or other related data could be communicated between devices. Additionally firmware images and biomechanical models may additionally be transferred between devices.

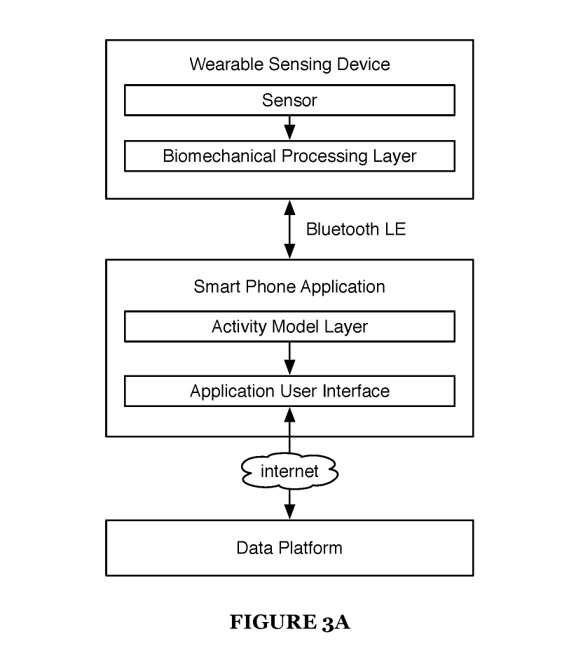

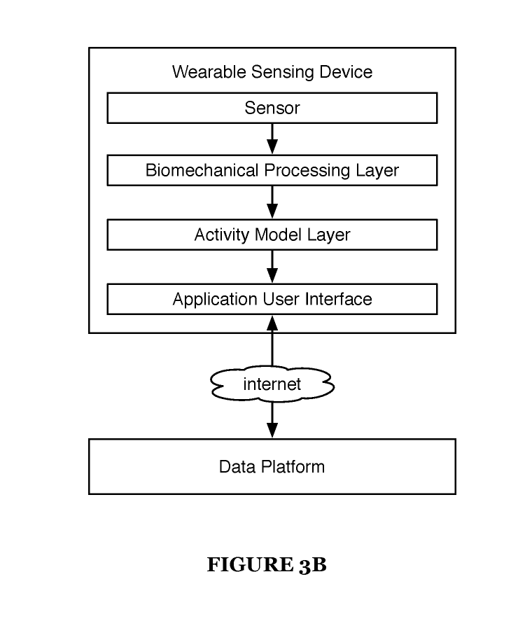

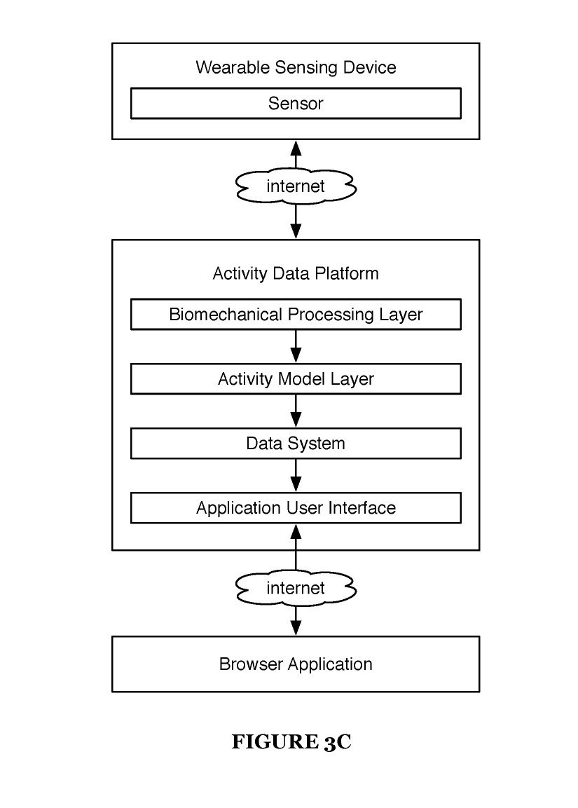

The distribution of the system components can be divided in a variety of ways. As shown in FIG. 3A, the wearable sensing device can be a simple sensing device with a communication channel to the application on a secondary computing device. The wearable sensing device can include the sensor and the biomechanical processing layer 110. The biomechanical processing configuration can be integrated into the device firmware to generate the biomechanical signals on the device. The biomechanical signals to a secondary device such as a smart phone. The biomechanical signals can be communicated in place of raw sensor data. The application can perform a substantial portion of the activity monitoring processing, user interactions, and communication with the data platform. As shown in FIG. 3B, a wearable sensing device can integrate a substantial portion of the activity tracking. The wearable sensing device can include the sensor, the biomechanical processing layer 110, the activity model layer 120, and a user interface. In this variation, the system may not rely on an intermediary device for user interactions. As shown in FIG. 3C, the wearable sensing device can be a simple sensing device that communicates the sensed data to a remote network accessible computing platform. The activity monitoring processing can be performed substantially in the cloud. The wearable sensing device may communicate directly to the computing platform using a data connection or Wi-Fi internet connection, but the wearable sensing device may alternatively relay the sensor data through a bridge device/application such as a smart phone. The system may support additional and/or alternative use-case integration architectures.

The data platform 140 of a preferred embodiment functions to be a centralized data management, analytics, and warehousing system. Data from various use-case instances is preferably synchronized with the data platform 140. The data platform 140 can include an application programming interface (API) or user portal. A user portal can provide data insights into the collected data. In one variation, a user portal is accessible by an end user of a use-case instance. The end user may review his or her activity, view analysis of their activity, and receive direction on performance. The user portal may alternatively be for an administrator accessing data records of a plurality of end-users. For example, a developer may be able to view collective data reports of the end users that are using their use-case integration. The data platform 140 may additionally include data processing systems that perform data analysis. The data analysis can be for individual end-users or for groups of users. The data analysis may be for informational purposes but may additionally be used in augmenting and updating other portions of the system. In another variation, the data platform may contain a number of machine learning or artificial intelligence models that process the raw data and return values that can be stored in the data platform or made available via API to third-party application. In one variation, machine learning can be used for automated management and customization of biomechanical processing configurations across a set of wearable sensor devices.

### 2. Method for a Wearable Technology Platform

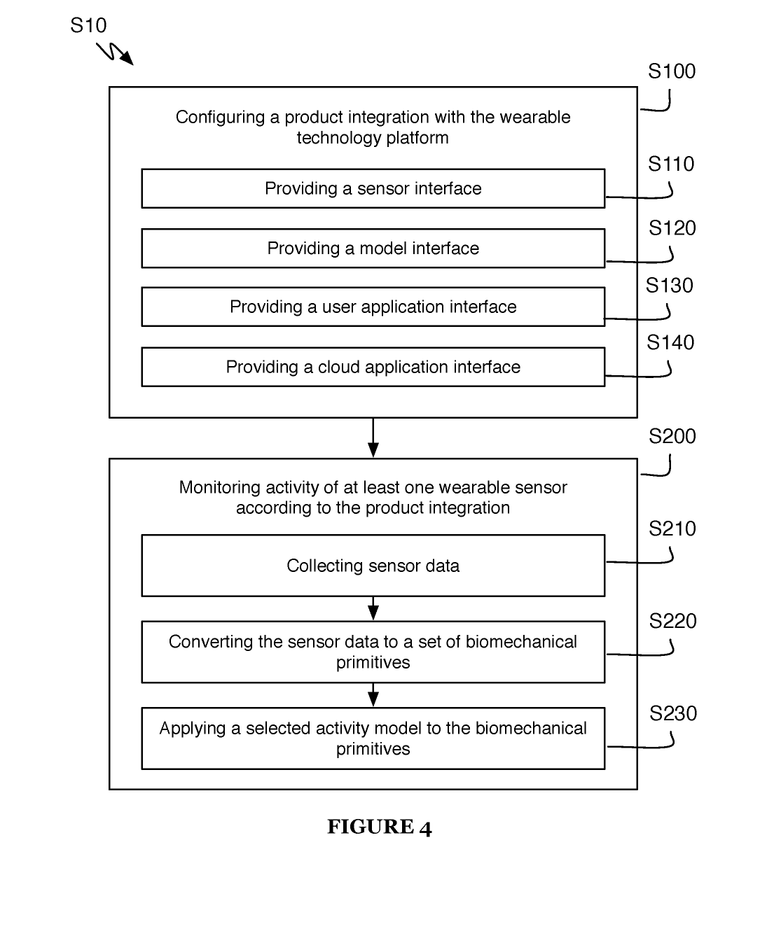

As shown in FIG. 4, a method S10 for a wearable technology platform of a preferred embodiment includes configuring a product integration with the wearable technology platform S100 and monitoring activity of at least one wearable sensor according to the product integration S200, wherein monitoring activity includes collecting sensor data S210, converting the sensor data to a set of biomechanical primitives S220, and applying a selected activity model to the biomechanical primitives S230. The method functions to provide a customizable platform for operating the infrastructure of a biomechanical driven wearable product. Preferably, the method is implemented a plurality of times by different entities to support multiple products through the configurable platform. The method may be used in offering a multitenant platform where multiple products and/or services implement various product integrations through a single wearable technology platform. Alternatively, the method be employed within a platform controlled by a single entity—the method can provide a simplified platform for expanding product offerings. The method may additionally be used in managing various instances of a product. For example, a company working on a product in the development stage may roll out different biomechanical processing configurations and/or activity models that are being tested with various user groups. As described below, the configuration of product integration with the wearable technology platform can be applied to creating dynamic cloud managed biomechanical processing configuration across a set of wearable sensors.

Block S100, which includes configuring a product integration with the wearable technology platform, functions to enable one or more product and/or services to be integrated into a wearable technology platform. The wearable technology platform is preferably substantially similar to the system described above. Configuring a product integration with the wearable technology platform can occur at various aspects of the technology stack. In some instances, only one layer is exposed for customization. For example, the biomechanical processing configuration of the biomechanical sensing layer may be customizable. Alternatively, multiple entities can integrate product offerings at different layers. A developer may build out a product integration that uses one or more aspects of the wearable technology platform. Block S100 can include providing a sensor interface S110, providing a model interface S120, providing an application interface S130, and/or providing a data interface S140. A developer may build customized functionality through each interface. However, a developer can preferably leverage existing solutions and focus development on a subset of the technology layers.

Block S110, which includes providing a sensor interface, functions to enable physical product developers to integrate their physical product into the technology stack. The sensor interface can provide one or more interfaces through which product developers can integrate with and be usable on the platform. In one variation, the sensor interface can be sensor platform firmware that can interoperate with various sensors. The sensor platform firmware can be installed with hardware of the product developer. In another variation, the sensor interface can be an integrated hardware solution that product developers can source and use within their products. The sensor interface can be used to integrate various types of sensors like: additional types of motion sensors such as IMUs and the like; additional types of environmental sensors such as altimeters, barometers, temperature sensors, and the like; additional types of biosensors such as sensors for heart rate, EMG, blood chemistry, brain activity, and the like; additional types of equipment sensors like sensors for bikes, baseball bats, golf clubs, and the like; and/or other suitable forms of sensors. The sensor interface can additionally be used to expand the type of sensor data collected through a sensor. A number of standard types of sensor measurements may be supported by default, but the sensor interface can enable alternative or additional forms of sensor data to be collected and used within the platform. The sensor interface can give flexibility to also create new products with new or different form factors. For example, different garment form factors can use different integration technology.

Through use of the sensor interface, a product developer can be alleviated of building out signal processing processes to interpret sensor data, designing electrical circuit boards with specific sensors, building complex application logic to interpret biomechanical properties, managing communication and syncing of data between various components, developing a user interface for a secondary device, and/or building and hosting a data platform. Collecting sensor data S210 preferably includes collecting sensor data through the sensor interface. A sensor interface is preferably a standardized approach to communicating sensor data. In one variation, the standardized approach specifies a data communication protocol. The data communication protocol may define data object formatting, the required data fields, and the optional data fields. For example, a data object may require acceleration in three different axes. A consumer electronic company that is working on a new wearable activity monitor can conform to the data communication protocol to make a device compatible with the wearable sensing platform. The sensor interface can additionally be used in communicating to a sensing device. In one variation, messages, software updates, and/or firmware can be pushed to sensing device through the sensor interface. Additionally, the standardized approach can specify a particular set of electronic sensing components. The allowed set of electronic sensing components may have been pre-calibrated and certified for use with the platform. Specialized data processing routines can be defined to account for various differences in the sensing components. In another variation, the standardized approach may specify a specific wearable sensing device, which can be integrated into various products. Each individual wearable sensing device may be uniquely identifiable so that they can be associated with a particular product integration configuration of a developer. For example, a garment manufacturer may register a set of sensing devices that ship with a pair of shorts. The garment manufacturer can configure how the sensing devices integrate with the wearable technology platform.

The sensor interface can additionally include a sensor-processing interface, wherein the transformation of sensor data can be defined through a biomechanical processing configuration. A set of different biomechanical processing configuration options can be accessible within the platform. The biomechanical processing configuration options can define a set of biomechanical signal sensing routines. The biomechanical processing options may alternatively define processing properties such as various threshold values, weights, or other values used in generating a biomechanical signal. Biomechanical processing operations used in a product developer's integration may be designed by the product developer, provided by the platform, or offered by other product developers of the platform. For example, a predefined biomechanical processing configuration for a pelvic sensor can include processes for forward velocity properties of the pelvis, vertical oscillation of the pelvis, ground contact time, pelvic rotation, and/or pelvic drop. Other biomechanical processing configurations may offer an alternative approach to calculating one or more biomechanical signals such as pelvic drop. Other biomechanical processing configurations may offer processes to generate additional or alternative biomechanical signals. Various biomechanical processing configurations can be defined for different types of sensors with different capabilities, different positioning, different activities, and/or different user attributes (e.g., age, sex, experience). The biomechanical processing configuration can preferably be changed. In one variation, various configuration options (e.g., from as simple as a property change to a full firmware update change) can be selected through an interface of the system and delivered to the wearable sensing device where it is installed and used. The biomechanical processing configurations can preferably be selectively delivered to specific wearable sensing devices (e.g., a wearable sensing device of a particular user, wearable sensing devices used by a particular demographic of user, or wearable sensing devices that are part of a product developer's integration). In another variation, machine intelligence in the wearable sensing device is used to augment a biomechanical processing configuration to alter its performance.

Block S120, which includes providing a model interface, functions to enable activity models to be defined and/or augmented. An activity model preferably processes a set of biological signals and triggers various events according to a defined set of heuristics based on the biological signals. The activity model can control a user feedback device such as a display, audio device, a haptic feedback device, and/or any suitable aspect. The activity model may alternatively be used to alter or control any suitable device. The activity model can be used to trigger actions in real-time. For example, audio guidance can be played for a participant when biking. The activity model can alternatively alter events after completion. For example, a report on running form can be logged for a user to review after a run.

The model interface can provide a tool to define and integrate a new activity model into the platform. An activity model can be private and only used for other integrations by a particular account. An activity model can alternatively be made public such that other entities can use the activity model. The model interface can alternatively provide a tool that enables an existing activity model to be modified. For example a subset of the heuristics for a walking activity model can be altered for a more specialized walking activity model focused on walking for fitness. The model interface is preferably operable on a user application to direct user feedback elements managed by the user application (e.g., audio played by a smart phone). The model interface could alternatively be operable on a wearable sensor and/or a data platform.

In one preferred implementation, a model interface can be a set of actions registered to particular conditions based on activity context and/or biological signals. The activity context can include if this is the first time the activity has been performed, how many times the activity has been completed in a particular time window (e.g., a user hasn't gone running in over a month), if the user has completed the activity, or other suitable contextual information relating to the activity. The biological signal conditions may result in different events when one biological signal or multiple biological signals satisfy a condition. The events in one implementation can be scripted audio messages played to the user. The model interface can be used to provide a wide variety of types of activity models. An activity model can be targeted at: particular activities such as running, walking, swimming, biking and the like; skill levels within an activity such as for an activity model for beginner and advanced models; training goals such as a 5K runner, 10K runner, or a runner looking to lose weight; and logic models for other segments. The activity model is preferably used to provide feedback and goals for a user based on the objective of the activity model, the biomechanical signals from the biomechanical processing layer, activity performance (e.g., time and distance), and other factors.

Block S130, which includes providing a user application interface, functions to provide programmatic access to various information. The application interface is preferably targeted at a developer building a native application for a computer, smart phone, tablet, or any suitable device. The application interface can be a software development kit (SDK), a library, an application programming interface (API), or any suitable programmatic interface. The application interface may integrate with the events of an activity model. The application interface can additionally or alternatively provide access to biological signal data, sensor data or information, data analytics from the data platform, wearable sensor device elements (e.g., a display or lights), data-platform integration, and/or any suitable component involved in product use by a user. In one variation, the application interface is used in combination with the activity model interface, wherein a customized activity model is defined in combination within an application.

Block S140, which includes providing a cloud application interface, functions to enable collected and/or processed data to be accessed and remote actions and changes to be performed. The data platform preferably includes an application programming interface so that data records can be queried and/or accessed. Data may be accessed and managed according to individual user accounts. The data may alternatively be processed as a group. Various data analysis processes can be performed to provide global or superset activity data. For example, the average bounce height for a runner of a particular height can be one data query that the data interface could support. The data interface may additionally provide capabilities such that activity data and/or related metadata can be added to the data platform. Similarly, various aspects of the system may be managed through a cloud application interface. For example, the biomechanical processing configuration and/or the activity model may be remotely updated from the cloud application interface.

Block S200, which includes monitoring activity of at least one wearable sensor according to the product integration, functions to operate the wearable technology platform on behalf of a wearable sensor instance. A particular sensor that is used by an end user will have been configured for a product integration with the platform. A given product with a sensor is preferably setup to use an activity model, interact with one or more apps, and synchronize data through the data platform. A developer of the sensor may have provided a biomechanical processing configuration. Alternatively, biomechanical processing configuration may be customized based on a variety of attributes such as the user properties, the currently synchronized application, or performance history. As mentioned, monitoring activity preferably includes collecting sensor data S210, converting the sensor data to a set of biomechanical primitives S220, applying a selected activity model to the biomechanical primitives S230.

Block S210, which includes collecting sensor data, functions to obtain sensor data from a wearable sensor device. The sensor data preferably includes a set of kinematic metrics measured from a substantially single point or a set of points. The kinematic metrics can be data outputs of an IMU or any suitable sensor such as a heart rate sensor, blood pressure sensor, galvanic skin response (GSR) sensor, and the like. The kinematic metrics may include acceleration metrics along three perpendicular axes. More preferably the IMU is a 9-axis IMU providing accelerometer data, gyroscope data, and magnetometer data along three axes. In one variation, kinematic metrics may be collected for different distinct points, wherein each distinct point corresponds to a different sensor device. Any additional or alternative sensor data may be collected. Additional information such as location, ground speed, altitude, and other aspects may be sensed through the wearable device or obtained through alternative mechanisms. For example, the location services of a smart phone can preferably be accessed and used in calculating an average ground speed.

Block S220, which includes converting the sensor data to a set of biomechanical primitives, functions to translate sensor data into a biomechanical interpretation. The biomechanical processing configuration preferably defines the processes to apply on the sensor data to generate the biomechanical signals. By generating biomechanical primitives, activity models can be defined based on actual biomechanical performance of an activity as opposed to non-specific sensor metrics. The set of biomechanical primitives is preferably selectively defined by the sensor data, the location of the sensor, and/or the activity. The kinematic sensor data can determine which biological signals are generated. Additionally, the location associated with the kinematic data determines how the sensor data is converted. A conversion process may be configured for a particular integration. In some variations, the platform may provide access to pre-defined sensor conversion processes.

In an preferred implementation, where the sensor data is collected from a waist region during a running activity, the generated biomechanical signals can include cadence, ground contact time, braking, pelvic rotation, pelvic tilt, pelvic drop, vertical oscillation of the pelvis, forward oscillation, forward velocity properties of the pelvis, step duration, stride length, step impact, foot pronation, foot contact angel, foot impact, body loading ratio, foot lift, motion paths, and/or other running stride based signals.

The method can include changing the biomechanical processing configuration of a wearable sensor. The biomechanical processing configuration can change in response to updated user information, performance of the user, state of an activity or activities, synchronizing an new or different application to the wearable sensor, an action on an application, user input, a remote command from the data platform, automatically detected changes in activity, or any suitable event. A change to a biomechanical processing configuration preferably involves a data option of some configuration option being sent from the data platform to user application and to the wearable sensor. The wearable sensor preferably updates to a new biomechanical processing configuration based on the configuration option. If the configuration option is a parameter change, then the appropriate parameter or parameters can be updated in the current processing configuration. If the configuration option is a change to a processing routine for a particular biomechanical signal, then the processing routine for that particular biomechanical signal can be changed. If the configuration option is a replacement biomechanical processing configuration, then the previous biomechanical processing configuration can be replaced by the new biomechanical processing configuration.

Block S230, which includes applying a selected activity model to the biomechanical primitives, functions to execute application logic defined for an activity model. The biomechanical primitives and additional contextual data may be delivered to an activity model. The activity model can be processed on the wearable sensor device, on a secondary device (e.g., a smart phone, tablet, another wearable computer, computer), or in the cloud. One type of action of an activity model can include notifying a user. Notifying a user can include playing an audio alert, displaying an alert, triggering a haptic feedback device, or performing any suitable task. Another type of action of an activity model can include triggering programmatic event. Triggering a programmatic event can include changing operating state of an application. For example, the control flow of an application may be determined based on when and how a programmatic event is triggered. Triggering a programmatic event can additionally include executing actions transparent to a user.

The method can include changing an activity model. The activity model can change in response to an application, user input, a remote command from the data platform, automatically detected changes in activity, or any suitable event. In a first variation, an activity model may be changed based on a change in operational mode. A user input or programmatic input may signal that the type of activity has changed. For example, a work out app may guide a user through different drills; each drill may have a customized activity model. The activity models can be changed based on the user completing each drill. The method can additionally include detecting an activity and automatically switching to an associated activity model. One variation of an activity model is an activity detection model, which monitors the biomechanical signals and other factors to determine what activity a user is currently performing. In one variation, each type of activity can have particular biomechanical signal signature. That activity signature can be customized for each individual user.

The method can additionally include storing activity data in a data platform. Storing activity data in the data platform includes communicating the data to the data platform and storing the data in a data warehousing system. The activity can include event information or other suitable information generated by an activity model, the biomechanical signals, the sensor data, and/or other suitable aspects. The data platform can serve or otherwise supply the data to authenticated entities in response to a request. The data platform may additionally process the stored data. In one variation, the data can be processed and the results applied to augment or alter the biomechanical signal processing, activity models, or other aspects of a product integration. Machine intelligence can be applied to an individual user data, account data, platform data, and/or data any suitable scope of data to improve results of sensor processing, the logic model, and/or other aspects.

A product developer that has used the system to build a use-case integration can preferably manage their account through an administrator interface. The product developer could remotely control all associated devices Remotely managing a use-case integration may include pushing a firmware update to a select set of sensing devices, updating sensor processing, updating an activity logic model, or performing any suitable remote change.

### 3. Method for Programmatically Customizing Biomechanical Sensing

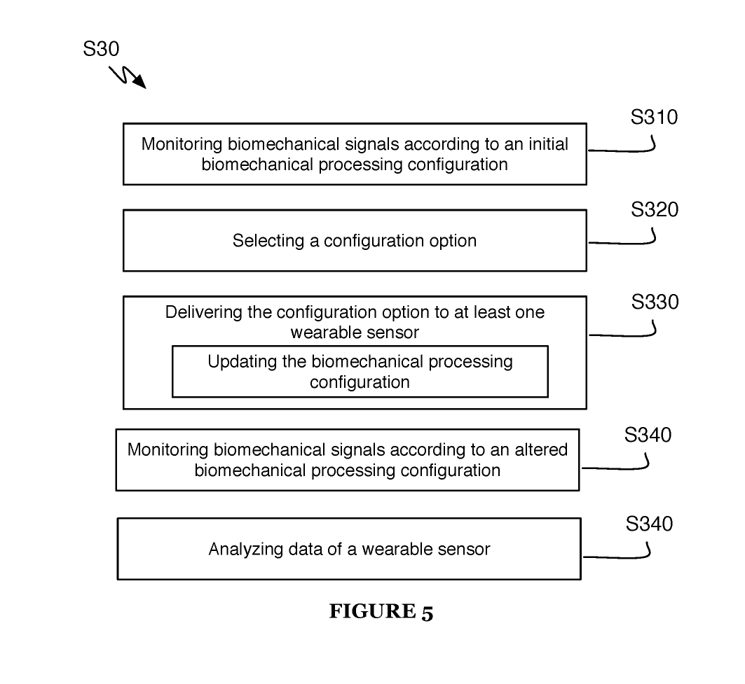

In one particular implementation of the method S10 described above, the various approaches are applied to a method for programmatically customizing biomechanical signal detection across a diversity of devices S30. The method S30 for programmatically customizing biomechanical signal detection across a diversity of devices can include monitoring biomechanical signals according to an initial biomechanical processing configuration S310, selecting a configuration option S320, delivering the configuration option to at least one wearable sensor S330, and monitoring biomechanical signals according to an altered biomechanical processing configuration S340 as shown in FIG. 5. The method S30 functions to enable remote configuration of one or more wearable sensors, which may be used for biomechanical sensing upgrades, user or user set upgrades, testing, and/or other applications. The method S20 is predominantly described as altering wearable sensor device firmware and/or the biomechanical signal processes, but the method S30 could similarly be applied to an activity model on a user application.

Block S310, which includes monitoring biomechanical signals according to an initial biomechanical processing configuration, functions to execute or perform a first version of activity data processing at one or more wearable sensors. More specifically monitoring biomechanical signals includes collecting kinematic sensor data and applying a biomechanical processing configuration to convert the kinematic data into a set of biomechanical signals. The biomechanical processing configuration is preferably the device firmware, instruction set, or other suitable form of computer readable directives for generating biomechanical signals from the kinematic data Biomechanical processing configuration preferably defines in part or whole the processing of kinematic activity data on a wearable sensor. The biomechanical processing configuration may define a set of processes for converting kinematic data (e.g., motion data from an accelerometer and/or gyroscope) into one or more biomechanical signals. In some implementations, the biomechanical processing configuration can be the firmware of the wearable sensor. The biomechanical processing configuration could additionally or alternatively include a set of operating properties used by a processing routine, such as a threshold value or a set of coefficient values.

A set of wearable sensors is preferably configured with the initial biomechanical processing configuration. The set may be a set of a single wearable sensor used by one user, but could alternatively be a subset of all wearable sensors or all wearable sensors integrated with a platform, wherein a single wearable sensor is delivered the configuration option in block S330. The set of wearable sensors may alternatively be all wearable sensors managed by the system or an account of the platform. The set of wearable sensors may alternatively, be a subset of wearable sensors of the system or an account of the platform. In some variations, the initial biomechanical processing configuration can be a default wearable sensor configuration. The default wearable sensor configuration could have preset activity tracking processes. The default wearable sensor configuration may be set based on the type of product. For example, a running product can include a default running configuration. The default wearable sensor configuration may alternatively be a blank setting that, a user or system can initialize through the method.

In one variation, the method S30 may be applied iteratively. Accordingly, the initial biomechanical processing configuration may be a configuration option previously updated through a previous iteration of the method S30. That is to say, a wearable sensor may initially operate with a first biomechanical processing configuration version, then updated and operated in a second biomechanical processing configuration version, and then updated and operated in a third biomechanical processing configuration version or any suitable number of configuration versions. For example, a first biomechanical processing configuration version may be a default version that ships with a product; when the user synchronizes an application to the wearable sensor and enters some basic user information, the biomechanical processing configuration may be updated to a biomechanical processing configuration selected for the user's demographic information; and then the biomechanical processing configuration can be updated again for another reason such as performance gains or an algorithm change by an administrator.

Monitoring biomechanical signals preferably includes a wearable sensor collecting kinematic sensor data and converting the kinematic sensor data into a set of biomechanical signals. Monitoring biomechanical signals can be substantially similar to Blocks S210 and S220. In one implementation, the biomechanical signals can be running biomechanical signals associated with step-based biomechanical metrics. The biomechanical signals may alternatively relate to other activities such as walking, biking, swimming, golfing, lifting, etc.

Block S320, which includes selecting a configuration option, functions to determine an augmented biomechanical processing configuration for at least one wearable sensor. A remote computing resource preferably selects the configuration option. The remote computing resource is preferably a server of the data platform, but may alternatively be a user application operable on a personal computing device or any suitable computing resource.

A configuration option preferably characterizes a change to the biomechanical processing configuration of a wearable sensor such that how the sensor data is processed is altered in at least one way. A configuration can be used to change the way a biomechanical signal is generated, adding a new biomechanical signal, removing a biomechanical signal, and/or changing the full set of biomechanical signals. Changing a biomechanical processing configuration may be used to improve the reliability, accuracy, performance or other attribute of how a biomechanical signal is generated. For example, one subset of runners may have a particular style of running that benefits from a different approach to generate a biomechanical signal. Changing a biomechanical processing configuration may alternatively be used to add a new biomechanical signal or to remove one. Changing a biomechanical processing configuration can alternatively be used to switch to a new activity type, a new wearable sensor location, new product, or new synched user application. The configuration option selected in Block S320 can direct how such a change is updated on a wearable sensor.

With such a variety of types of changes, a configuration option can take on various formats. The configuration option can be a distinct biomechanical processing configuration, which can be firmware data that includes distinct processing routines and/or operation logic. For example, the configuration option may specify the biomechanical processing routines for cadence, ground contact time, and pelvic rotation. The configuration option could alternatively be a defined change or partial update to the current biomechanical processing configuration. For example, the configuration option could define a single biomechanical process such as cadence and/or a parameter of a biomechanical process such as a threshold value. The configuration option could alternatively be one or more operating parameters of the biomechanical processing configuration. For example, the configuration option could specify a particular threshold and/or weighting factor that should be updated in the current biomechanical processing configuration.

The selection of a configuration option can be initiated through a variety of events and/or mechanisms. In one variation, selecting a configuration option comprises receiving a processing alteration event S322. A processing alteration event can be received through a graphical user interface and/or a programmatic interface. A graphical user interface could be an administrator interface, where changes to deployed wearable sensors, subsets of wearable sensors, and/or individual wearable sensors may be made. A programmatic interface can similarly be used such as an application programming interface.

A processing alteration event may similarly be initiated in response to a new version of the biomechanical processing configuration. Updates could be automatically delivered when improvements or changes are made.

A processing alteration event preferably specifies the configuration option to be selected. The processing alteration event can be an internally activated event (e.g., the platform detecting some data pattern) or an event caused by an outside entity (e.g., a product developer or system operator using a administrator interface to push a change to some wearable sensors). In one variation, the processing alteration event is a request received through a user interface or a programmatic interface (e.g., a public API). The request can specify how a configuration option is to be generated to deliver to a wearable sensor. Additionally, the request specifies the set of wearable sensors to receive the configuration option. For example, a sports apparel entity may use an administrator interface to select a particular group of devices, such as all the devices in a particular country, and push a change in their biomechanical processing configuration.

In one variation, the wearable technology platform supports management and control across a diverse set of devices and systems. A wearable sensor can be specified and/or addressed according to various wearable sensor attributes such as device information, user information, geographic information, and/or any suitable information. Device information could relate to the type of the product, the brand associated with a wearable device (e.g., two brands may each have their own product powered by the wearable sensor), and/or other product attributes. For example, when the platform manages a wide variety of products, changes could be pushed to running activity sensors, eyeglass activity sensors, or other suitable smart products with activity monitoring capabilities of the system. User information could include a unique user identifier, demographic information, and/or any suitable user attribute. Additionally or alternatively, a wearable sensor could be individually specified using a wearable sensor identifier.

In one variation, a configuration option may be delivered to only wearable sensors that match the property characteristics at the time of the request. Alternatively, a configuration option may be set to be delivered to any wearable sensor that matches a pattern of properties now and in the future. For example, a biomechanical processing configuration version may be set to be delivered to any wearable sensor where the user has an average running mile time less than a certain threshold. In another example, a biomechanical processing configuration version may be set to be delivered based on the training plan of the users. Users training for a marathon may be updated differently from users training for weight loss.

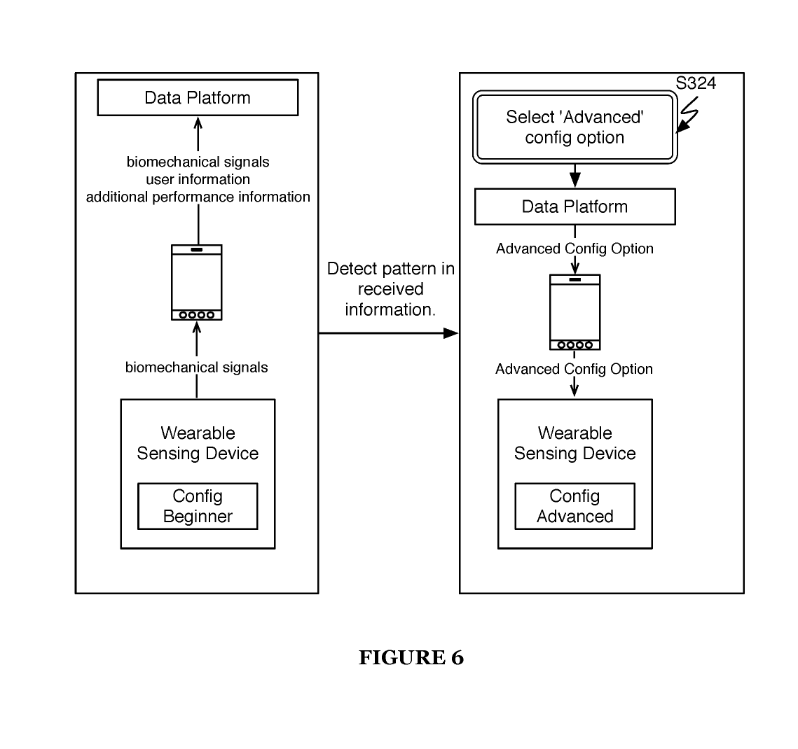

In one variation, selecting a configuration option can include automatically initiating selection of the configuration option according to received information of the user S324 as shown in FIG. 6. The received information can relate to a number of aspects such as user demographics, biomechanical signal values, performance metrics, and/or any suitable information. For example, a user may provide basic demographic information such as sex, age, weight, height, general fitness level, and/or other suitable information. In another example, performance information can be retrieved. The performance information can be based on the monitored biomechanical signals. The performance could be a classification of the runner. The classification could characterize running form such as if a runner is classified as a light-step runner or as a heavy-step runner. The classification could additionally or alternatively rank the users according to form such as beginner form, intermediate form, and/or expert form. Performance information could additionally include information related to other activity information. For running, additional performance information can include average mile time, average running distance, and the like. The data platform, user application, or other suitable component may detect a pattern and trigger a processing alteration event.

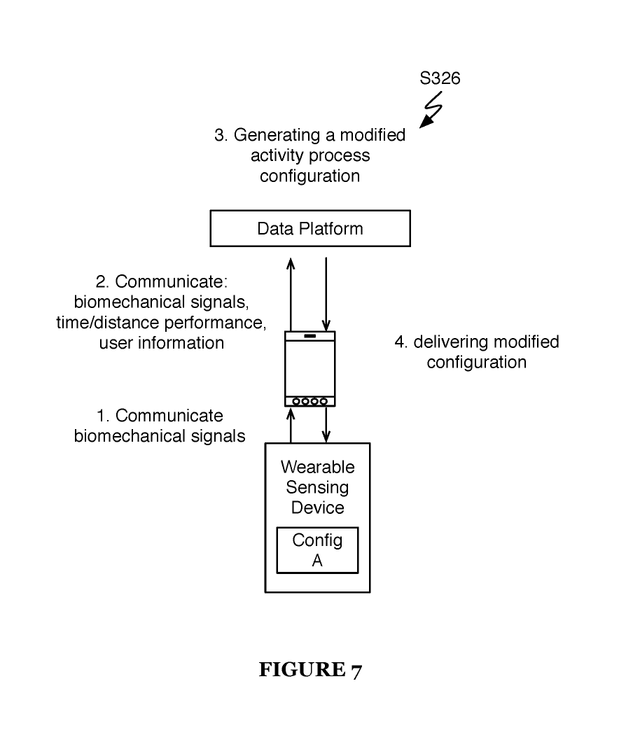

In another variation, selecting a configuration option S320 can include automatically generating a configuration option S326 as shown in FIG. 7. Machine learning or other machine intelligence can be used to generate, modify, and/or otherwise create augmented biomechanical processing configurations. Machine intelligence is preferably applied to wearable sensor information, resulting biomechanical signals and/or performance information to dynamically create and assign biomechanical processing configurations. Machine learning or other forms of machine intelligence can be implemented in the data platform. The data platform can preferably use data across multiple users and multiple use-case integrations (e.g., different products, different sports, etc.). Machine learning or other forms of machine intelligence can additionally or alternatively be implemented on the wearable sensor. For example, machine learning can automatic tune operating parameters of an active biomechanical processing configuration. Changes and improvements may be synchronized with the data platform for distribution to similar cases.

Block S330, which includes delivering the configuration option to at least one wearable sensor, functions to wirelessly transfer data to install and/or establish the configuration option in a wearable sensor. The configuration option can be a firmware update but may alternatively be a configuration property that is updated on the wearable sensor. Upon being delivered to the wearable sensor, the operation option is preferably installed. In one variation, the configuration option overrides the current biomechanical processing configuration, wherein delivering the configuration option can include replacing the first configuration with the second configuration. In this variation, the configuration option can be or characterize a firmware update. In an alternative variation, the configuration option may be installed as an additional processing mode that may be selectively engaged by the wearable sensor. Delivering the configuration option can include, at the wearable sensor, enabling a second execution mode with the configuration option, and selecting the second configuration as the current configuration of the execution mode in preparation for or during block S340. Multiple biomechanical processing configurations may be stored and used depending on the mode of the wearable sensor.

Delivery can preferably be initiated in block S320 at a remote server, the configuration option data communicated to a user application on a personal computing device, and then the configuration data transferred to the wearable sensor. Alternatively, the configuration option data may be present on a user application, and the delivery route is a transfer between the user application and the wearable sensor. The data configuration data is preferably transferred between a personal computing device and the wearable sensor using a wireless substrate such as using Bluetooth Low Energy (BLE). As BLE and other wireless communication channels may have limitations for transferring large files like firmware update, a method for data streaming S40 described below may be used.

Block S330 can additionally include updating the biomechanical processing configuration of the set of wearable sensors to an altered biomechanical processing configuration. If the configuration option is an operating parameter change, then the parameter can be altered in the biomechanical processing configuration. If the configuration option is a change to one or the set of biomechanical signal processes, that change can be made. And if the configuration option is a replacement biomechanical procession configuration, then the current biomechanical processing configuration can be uninstalled and replaced with the updated biomechanical processing configuration as defined by the configuration option.

Block S340, which includes monitoring biomechanical signals according to an altered biomechanical processing configuration, functions to execute or perform a second version of activity data processing. The altered biomechanical processing configuration is preferably altered according to the configuration option. Block S340 is preferably substantially similar to Block S310, except in that the processing of kinematic data to generate biomechanical signals is new and/or modified. As mentioned above, monitoring biomechanical signals preferably includes collecting kinematic sensor data and applying a current biomechanical processing configuration of the set of wearable sensors to convert the kinematic data into a set of biomechanical signals. The current biomechanical processing configuration is preferably new or altered biomechanical processing configuration at this stage.

In practice, the method may be implemented in a number of various use-cases. Particular advantages can become more evident when applied across multiple sets of wearable sensors with multiple configurations. For example, two sets of wearable sensors can be managed independently where the biomechanical processing configuration can be individually updated. A multiple-configuration implementation can include: at a first set of wearable sensors that are configured in a first biomechanical processing configuration, collecting kinematic sensor data and applying the first biomechanical processing configuration to convert the kinematic data into a set of biomechanical signals; at a second set of wearable sensors configured in a second initial biomechanical processing configuration, collecting kinematic sensor data and applying the second biomechanical processing configuration to convert the kinematic data into a set of biomechanical signals; at a remote computing resource, selecting a first configuration option for the first set of wearable sensors and selecting a second configuration option for the second set of wearable sensors; delivering the first configuration option to the first set of wearable sensors and delivering the second configuration option to the second set of wearable sensors; updating the first set of wearable sensors to a first altered biomechanical processing configuration based on the first configuration option; updating the second set of wearable sensors to a second altered biomechanical processing configuration based on the second configuration option; at the first set of wearable sensors, applying the first altered biomechanical processing configuration to convert the kinematic data into a set of biomechanical signals; and at the second set of wearable sensors, applying the second altered biomechanical processing configuration to convert the kinematic data into a set of biomechanical signals.

As described herein, the platform may manage a variety of different wearable sensors. The multiple-configuration implement ation can be used to deploy different configuration variations to different subsets of wearable sensors. Wearable sensors may be segmented and selected to use particular biomechanical processing configurations based on product information, user demographic information, user activity performance, and/or any suitable property.

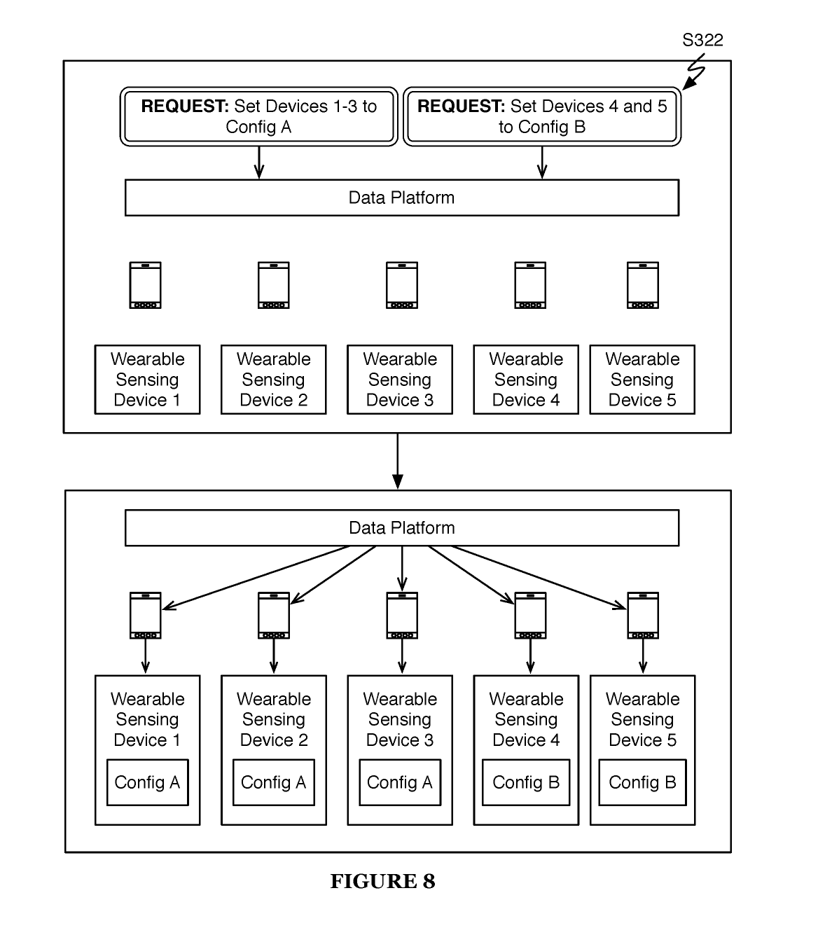

In one variation shown in FIG. 8, the first and second initial biomechanical processing configuration is the same biomechanical processing configuration. In this variation, a group of similarly operating wearable sensors can be split into two subsets with different configuration.

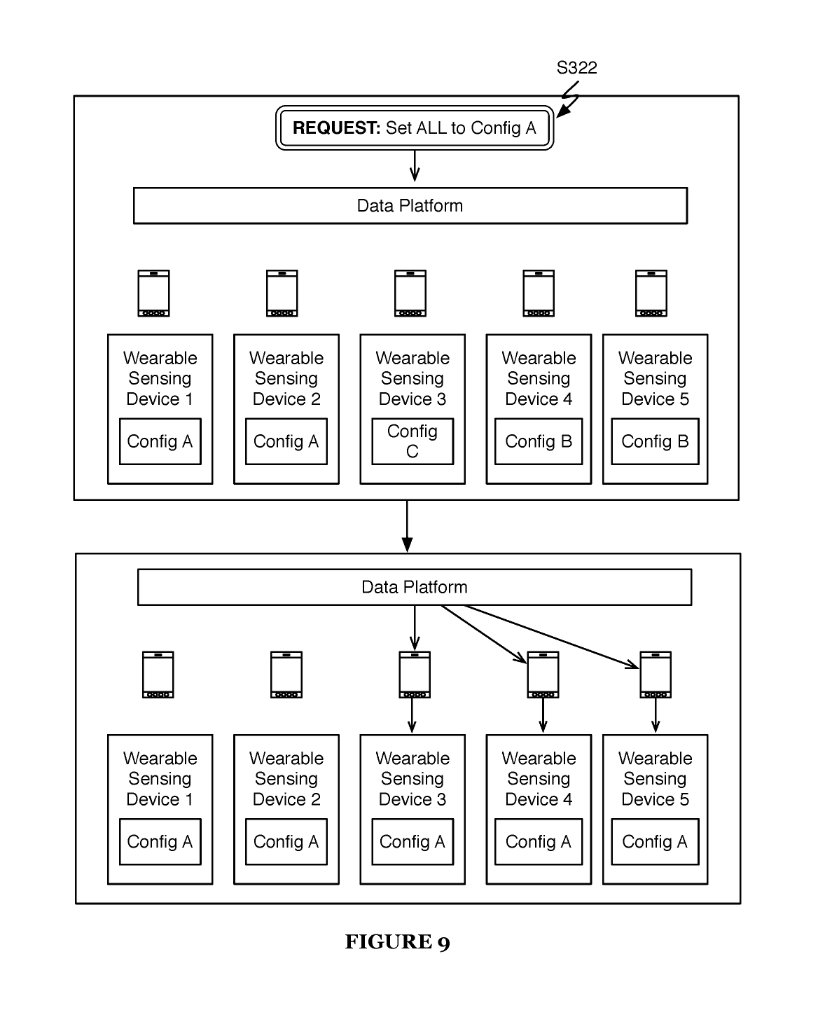

In one variation shown in FIG. 9, the first and second initial biomechanical processing configurations are different and the first and second altered biomechanical processing configurations are the same, wherein two groups of wearable sensors can be made to operate according to a similar configuration.

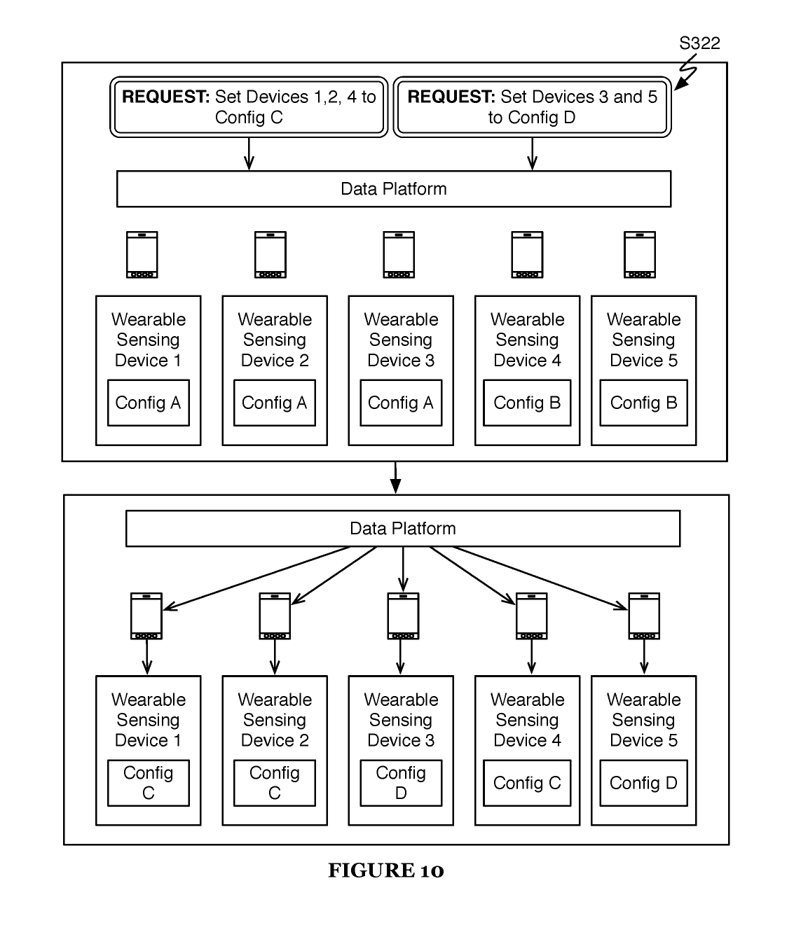

In one variation shown in FIG. 10, the first and second sets of wearable sensors are independently configured such that the initial and altered biomechanical processing configurations are different at both stages for the wearable sensors.

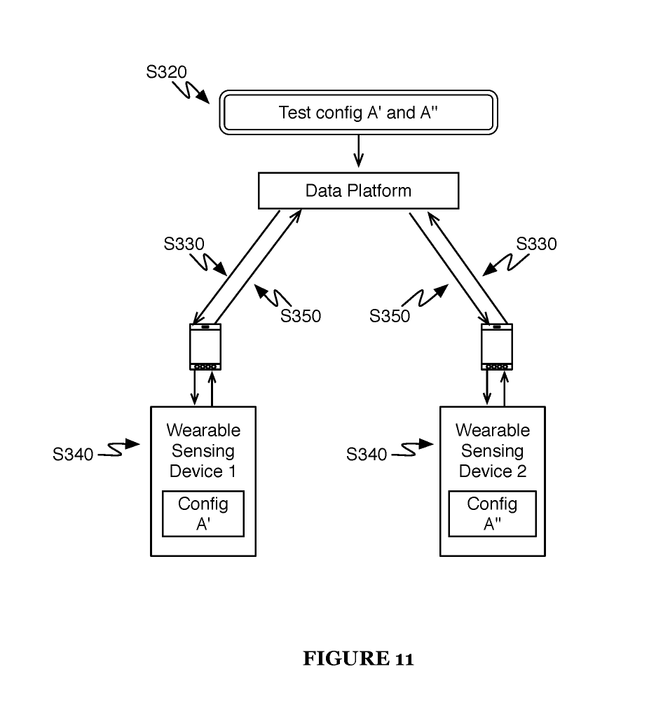

The method may additionally include analyzing data of the at least one wearable sensor S350, which functions to monitor the impact of the configurable option as shown in FIG. 11. Analysis of data from the wearable sensor is preferably utilized when multiple configuration versions are in use. Block S350 can be used to establish a feedback loop to inform and/or initiate selecting and delivering configuration options to the current set of wearable sensors or other wearable sensors.

Analyzing data can include comparing biomechanical performance levels from wearable sensors. This can be used to determine how the configuration options impacted the sensing capabilities and/or performance of a user. In one use case, this may be used for testing a configuration option against a control option (e.g., a placebo control option). In another use case, this may be used for performing A/B testing of configuration options.

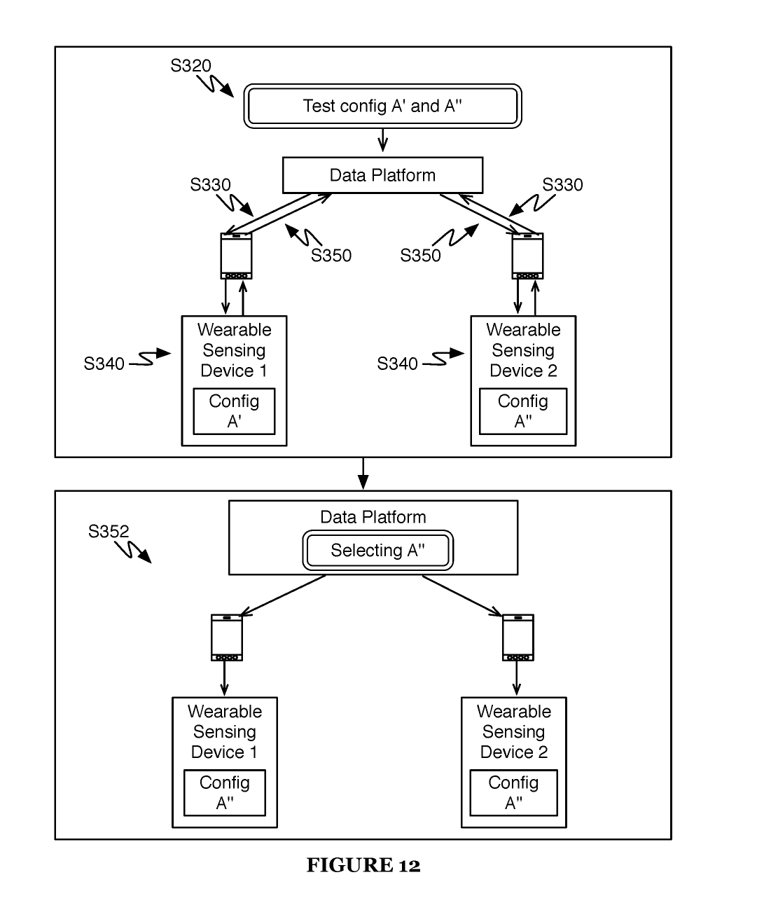

As shown in FIG. 12, an A/B testing variation can additionally include selecting a preferred configuration option and delivering the preferred configuration option to a third set of wearable sensors S352. The preferred configuration option is preferably selected from the first and second configuration options and is based on the performance levels. The third set of wearable sensors preferably includes wearable sensors outside of the set of wearable sensors associated with the preferred configuration option.

In a single wearable sensor implementation, the method can be used to automatically update the biomechanical processing configuration of a wearable sensor according to the performance level of the user. The biomechanical processing configurations may be targeted at sensing the biomechanical characteristics of an activity for a particular performance style. This performance style may change with familiarity, strength, age, or other properties. As shown in FIG. 6, a single wearable sensor implementation can include analyzing biomechanical performance levels of one wearable sensor; upon the biomechanical performance levels satisfying a condition for a new performance level, selecting an updated configuration option mapped to the new performance level; and delivering the updated configuration option to the one wearable sensor. For example, a user may begin a new activity at a beginner level and the initial biomechanical processing configuration used to analyze the user's biomechanics is targeted at a beginner. The performance levels as detected by the wearable sensor can be monitored. The wearable sensor can be automatically updated to a new biomechanical processing configuration when some condition is satisfied. The condition could relate to the biomechanical signals when performing the activity, the performance of the activity (e.g., satisfying time and/or distance thresholds), or any suitable condition.

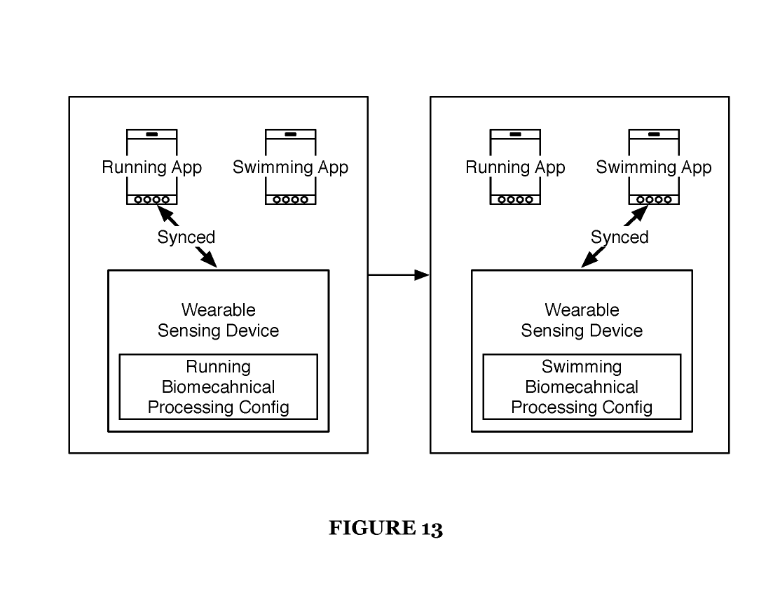

An application synching variation can be used to alter the biomechanical processing configuration based on the activity and/or application connected to the wearable sensor. In one variation, one user application may have multiple activities that can be tracked. In another variation, multiple applications for different activities may be usable with the same wearable sensor. The method can include synchronizing a first user application on a personal computing device to the wearable sensor; and selecting the configuration option according to the first user application, which functions to determine the configuration option based on the user application used to connect to the wearable sensor. The method can similarly use the application synchronizing variation when multiple applications are used with a user application. One variation can include synchronizing a second user application to the wearable sensor; selecting a second configuration option for the wearable sensor; delivering the second configuration option to the wearable sensor; and monitoring biomechanical signals at the wearable sensor according to an biomechanical processing configuration that is altered according to the second configuration option as shown in FIG. 13. Similarly, configuration options can be delivered when the user of a wearable sensor changes, which functions to allow multiple users share a single wearable sensor. The change in a user can be detected based on the current application synched to the device. For example, a woman may use a wearable sensor with her phone. The wearable sensor will preferably use a biomechanical processing configuration selected for her. Later, the woman's husband may use the wearable sensor with his phone. Then the wearable sensor will preferably use a biomechanical processing configuration selected for the husband. User associated biomechanical processing configurations can alternatively be selected for use based on a profile selected in a user application. In another variation, an auto classification routine may detect patterns in biomechanical signals and automatically select and use an appropriate user-associated biomechanical processing configuration. This can be particularly applicable when used within a smart product, which may not be particularly fitness based. For example, multiple people may share smart glasses. The smart glasses could automatically detect who is wearing the glasses from the biomechanical signals and select an optimized biomechanical processing configuration.

### 4. Method for Data Streaming for a Wearable Sensor

A user application on a personal computing device preferably communicates with the wearable sensor over a wireless communication channel. More specifically, the user application and the personal computing device communicate using a Bluetooth Low Energy (BLE) specification. BLE is generally designed for sending and receiving short pieces of data (sometimes referred to as attributes) using generic attribute profile (GATT) communication. In some instances traditional GATT can be restrictive in certain aspects, and a data streaming method may address several limitations and enable suitable data streaming capabilities. As one potential limitation in GATT, data is exchanged in the form of one or more “descriptors”, and GATT may limit the maximum length of such descriptors. As another potential limitation, GATT may not support detection of data units lost in transmission. As another potential limitation, GATT based communication may not support detecting data corruption during data transfers. The method can preferably utilize a streaming data transfer protocol to address such limitation (for GATT and other data protocols) to enable configuration options to be successfully and reliably transmitted from a computing device like a phone to the wearable sensor.

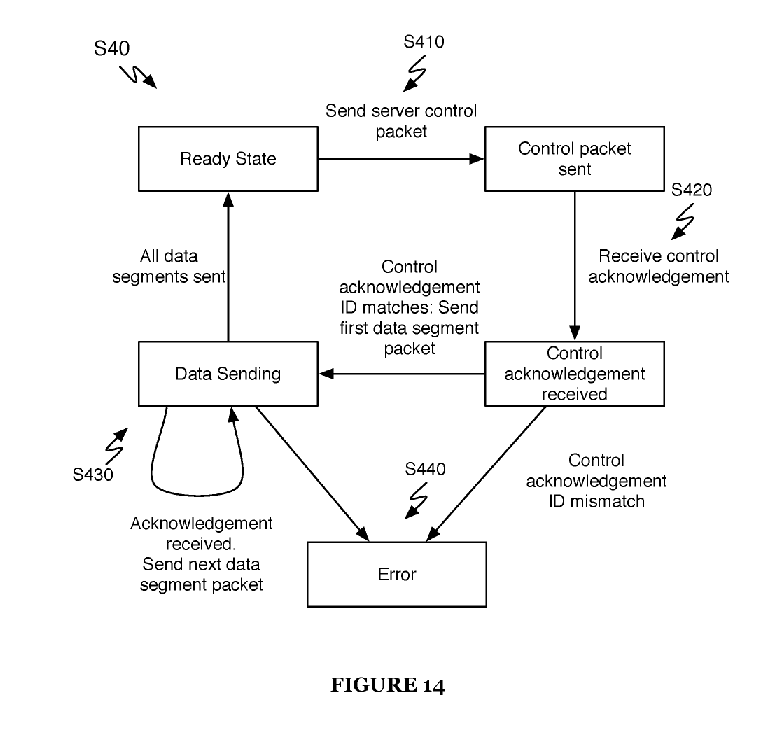

A data streaming method S40 used in delivering the configuration data and/or other data information to a wearable sensor can include initiating a transmission with a control packet transmission S410; receiving acknowledgment over the control channel S420; transmitting data stream packet in a data channel S430; and responding to an error state S440 as shown in FIG. 14. The data streaming method preferably has the user application at a personal computing device acting as a client and the wearable sensor acting as the server. Alternatively, the method may be implemented with the user application acting as the server and the wearable sensor as the client. Similarly, the method could be used for sensor-to-sensor communication or communication between any two devices. The data streaming method is preferably used for transmitting over a BLE link. The server preferably stores data transported by the client. The server can accept requests, commands, and acknowledgements from a client. The server sends responses to requests and when configured sends indication and notifications asynchronously to the client when specified events occur on the server. The client correspondingly sends commands, requests, and acknowledgements to the server. A command can be a request to the server to perform a read or a write operation to a specific characteristic or descriptor. Preferably, the data streaming method can be used in the method above for communication between a user application (a client) and a wearable sensor (a server). More specifically, the data streaming method can be used in delivering a configuration option to a wearable sensor, which may include transferring a firmware update for changing the biomechanical signal processing routines.

The data streaming method functions to reliably deliver data over a wireless communication protocol. In particular, the data streaming method can utilize attribute communication channel to establish a robust, reliable, and continuous data streaming channel.

As one potential benefit, the data streaming method can provide data integrity. The data streaming method preferably includes a checksum function applied to transmitted data to detect errors encountered during transmission.

As another potential benefit, the data streaming method can provide control and data channels. A control channel can introduce metadata that describes the properties of the data to follow.

As another benefit, the data streaming method can enable large data transfer over BLE. If the amount of data to be transmitted exceeds the maximum length supported by the underlying attribute based substrate as can be the case in traditional GATT BLE, the data streaming method can split data into multiple fixed length segments and each segment is transmitted independently by the Client/Server. The data streaming method can transfer the control information that is used by a transmitter (e.g., the server) in communicating metadata to the receiver (e.g., the client) and thereby enable the receiver in reassembling multiple data segments into a single data stream. If the data to be transmitted is less than the maximum length supported by the attribute based communication channel, multiple data units are coalesced to form a single data packet that is transmitted.

As another potential benefit, the data streaming method may utilize timeouts and retransmissions upon timeouts to facilitate early detection of errors to establish a robust transmission mechanism.

Block S410, which includes initiating a transmission with a control packet transmission, functions to prepare the wearable sensor for receiving streamed data. Initiating a transmission with a control packet transmission includes transmitting the control packet transmission from the client to the server. Each control packet is transmitted by the client to communicate metadata for the intended data packet to follow the control packet. The metadata is represented by various fields of the control packet, and the fields function to describe properties of the data packet.

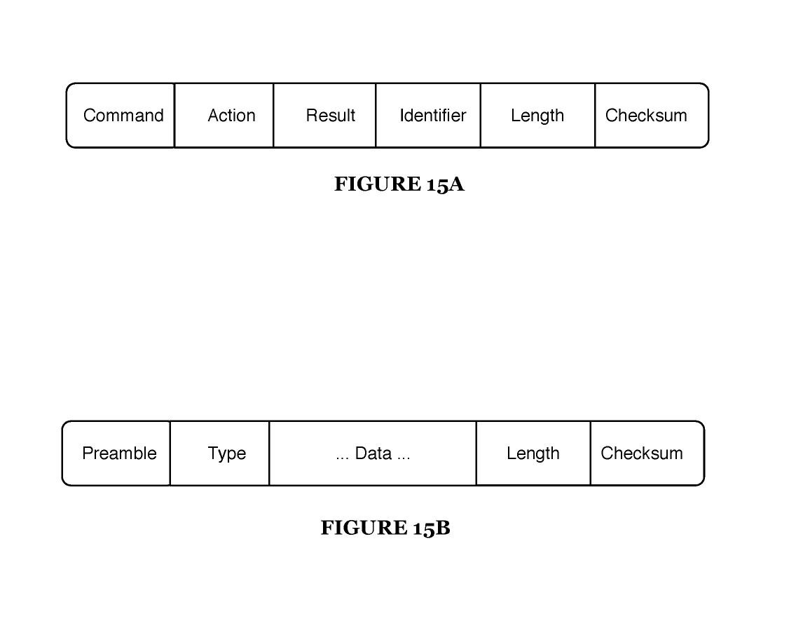

A preferred implementation of the control packet can include the fields: command, action, a result, identifier, a length, and/or a checksum as shown in FIG. 15A. Additional fields and/or an alternative set of fields may be used.

The command field preferably describes the command to be sent to the server. The action field describes the type of action to be executed. The server can react to each action in a unique manner. The result field describes the result of an action. The identifier can uniquely identify each control packet. The identifier can be used to match the received acknowledgments from block S420 with the transmitted control packet. The length field describes the length of the data packet that follows the current control packet. The data packet length is used to communicate the total length of the entire data packet. The checksum field is a checksum of the data packet that shall follow this control packet. The checksum is preferably a value used to ensure that data stored or transmitted without error. A checksum can be computed by running various algorithms on the data under consideration. The client preferably enters a state awaiting an acknowledgment packet after transmitting a control packet.

Block S420, which includes receiving acknowledgment over the control channel, functions to confirm receipt by the server. A server preferably sends back an acknowledgement packet for each control packet that is successfully received. When an acknowledgement is received by the client, the client enters an acknowledgement received state. The acknowledgement packet preferably includes an identifier that should correspond to an identifier of the control packet. The client preferably determines if the identifiers match. If the identifiers do not match then the client can enter an error state. If the identifiers do match, the client can proceed with transmitting data.

Block S430, which includes transmitting data stream packet in a data channel, functions to send a series of data packets that represent a data transmission. The source data to be transmitted can be of arbitrary length. The source data is preferably segmented into segments of fixed length for transmission in a transmission packet. The fixed length of each transmission segment is determined based on the maximum length that is supported by the underlying communication protocol (e.g., 20 bytes per BLE GATT characteristic value). The remote server uses data packet length field that was sent in the control packet along with segment length, to determine the expected number of chunks. This mechanism helps the server to calculate the end of data transmission for the current stream.

A transmission packet can include a number of fields such fields for: a preamble, a type, a data, a length, and a checksum as shown in FIG. 15B. The preamble is preferably the initial field in a transmission packet and is used to identify packets generated by the transmitting client. The preamble is preferably unique (at least to the scope of the recent communications of the server and client) and is used by the server to identify packets generated by the communicating client. The uniqueness of the preamble provides resistance to masquerading attack where another client may send data to the server instead of the actual client that had originally initiated the transmission. The type field specifies the action to be executed on the server. The data field is followed by a segment of actual data from the source data. The actual data is of fixed length across the data stream packets. The length field describes the length of the data within the current data packet. The checksum is a checksum generated from the client. The server preferably computes a new checksum of the transmitted data. The received checksum and the computed checksum can be compared to detect erroneous data transmissions.

After transmitting a data packet, the client preferably waits for an acknowledgement of the data packet. A subsequent segment is transmitted by the client after an acknowledgement of the previous segment is successfully received. The client preferably waits a predefined period of time for an acknowledgement. If no acknowledgement is received within this time period, the client enters an error state and no further data segments are transmitted. Generally, a server will transmit an acknowledgement upon successfully receiving a data packet.

Block S440, which includes responding to an error state, functions to take an action in response to some transmission error. A client may enter an error state if identifiers of a control packet and a control acknowledgement packet do not match. A client can also enter an error state if an acknowledgement is not received in response to a data packet. Recovery from an error state can be achieved through a variety of approaches. In one instance, the transmission process may restart. In another variation, the method could include detecting corrupted data packets and retransmitting only packets that were detected as corrupt during the transmission. In another variation, the transmission signal of the client and/or server may be adjusted to improve the communication channel.

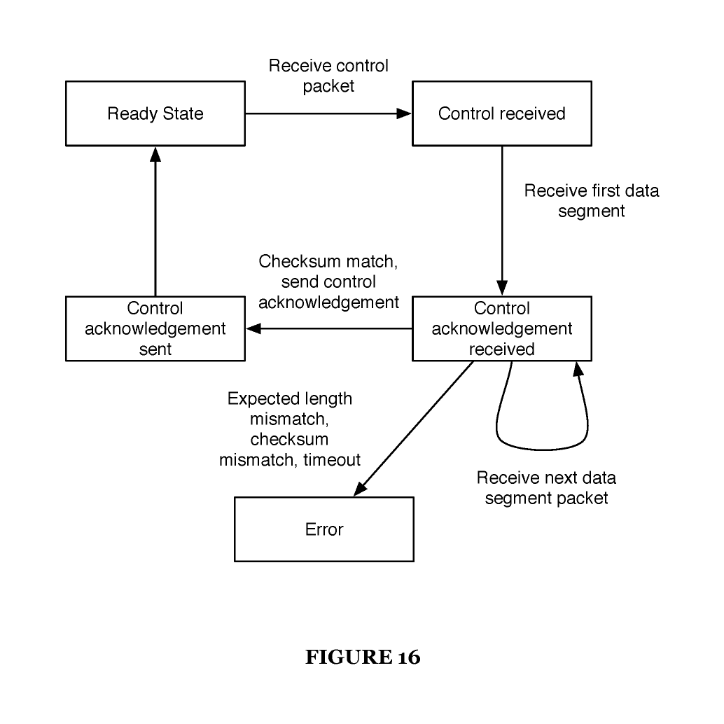

Additionally or alternatively, the data streaming method can support transmitting ad-hoc/asynchronous notifications, in particular notifications from a server to a client. The notifications can be transmitted to the client in a similar approach as above As shown in FIG. 16, a server may generate and transmit a control packet to the client. The control packet can be substantially similar to the control packet described above with various metadata fields describing the data transmission, such as an identifier field, a length field, and/or a checksum field. The client may transmit a control acknowledgement packet. The notification to be transmitted is similar to the source data in this variation, wherein the server segments the notification data into various segments for transmitting over several data packets. The data packets can have similar structure to above. The client may additionally have a timeout while waiting for the next data packet. If a data packet is not received within the timeout, the client can enter an error state. Once all the data packets are received as may be determined from the length field of the control packet, the client can compute and compare checksums, If the checksums do not match, the client can enter an error state for recovery. In one variation, the client may communicate the error to the server, and the server may retry.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method for customizing biomechanical wearable sensors comprising:
at a first set of wearable sensors, collecting kinematic sensor data and applying an initial biomechanical processing configuration to convert the kinematic data into a set of biomechanical signals;
at a remote computing resource, selecting a configuration option for the first set of wearable sensors;
delivering the configuration option to the at least one wearable sensor;
updating the initial biomechanical processing configuration of the first set of wearable sensors to an altered biomechanical processing configuration, wherein the altered biomechanical processing configuration is based in part on the first configuration option; and
at the first set of wearable sensors, applying the altered biomechanical processing configuration to convert the kinematic data into a set of biomechanical signals.

2. The method of claim 1, wherein the biomechanical signals are running and walking biomechanical signals associated with a step-based biomechanical metrics.

3. The method of claim 2, wherein the biomechanical signals include cadence, vertical step oscillation, step braking, pelvic drop, and pelvic rotation.

4. The method of claim 1, wherein selecting a configuration option for the first set of wearable sensors comprises receiving a processing alteration request at a cloud data platform, the request specifying the first set of wearable sensors and the configuration option.

5. The method of claim 1, wherein the first set of wearable sensors is a set of one wearable sensor associated with a user; and wherein selecting a configuration option for the first set of wearable sensors comprises analyzing the user information and selecting a configuration option based on the user information.

6. The method of claim 5, wherein the user information includes performance information based on the set of biomechanical signals and demographic information of the user.

7. The method of claim 1, further comprising:
at a second set of wearable sensors, collecting kinematic sensor data and applying the initial biomechanical processing configuration to convert the kinematic data into a set of biomechanical signals;
at a remote computing resource, selecting a second configuration option for the second set of wearable sensors;
delivering the second configuration option to the second set of wearable sensors;
updating the initial biomechanical processing configuration of the second set of wearable sensors to a second altered biomechanical processing configuration, wherein the second altered biomechanical processing configuration is based in part on the second configuration option;
at the second set of wearable sensors, applying the second altered biomechanical processing configuration to convert the kinematic data into a set of biomechanical signals.

8. The method of 7, further comprising analyzing usage data of the first set of wearable sensors in the altered biomechanical processing configuration and the second set of wearable sensors in the second altered biomechanical processing configuration.

9. The method of claim 8, wherein analyzing usage data comprises comparing biomechanical performance levels from the first set of wearable sensors to biomechanical performance levels from the second set of wearable sensors.

10. The method of claim of 8, further comprising selecting a preferred set of wearable sensors from the first and second set of wearable sensors based on the analyzed usage data; and delivering the configuration option of the preferred set of wearable sensors to a third set of wearable sensors.

11. The method of claim 1, wherein the set of wearable sensors is one wearable sensor associated with a user; further comprising analyzing biomechanical performance levels of the one wearable sensor; upon the biomechanical performance levels satisfying a condition for a new performance level, selecting an updated configuration option mapped to the new performance level; and delivering the updated configuration option to the one wearable sensor.

12. The method of claim 1, wherein the configuration option is a firmware update.

13. The method of claim 1, wherein the configuration option is a biomechanical processing parameter.

14. The method of claim 1, wherein delivering the configuration option comprises streaming the configuration option over Bluetooth low energy channel.

15. A method for monitoring biomechanical signals through a wearable sensor:
at a remote computing resource, selecting a configuration option for a first set of wearable sensors;
delivering the configuration option to the first set of wearable sensors;
updating the first set of wearable sensors to a first biomechanical processing configuration, wherein the first biomechanical processing configuration is based in part on the configuration option;
at the first set of wearable sensors, collecting kinematic sensor data and applying the first biomechanical processing configuration to convert the kinematic data into a set of biomechanical signals.

16. The method of claim 15, further comprising:
at the remote computing resource, selecting a second configuration option for a second set of wearable sensors;
delivering the second configuration option to the second set of wearable sensors;
updating the second set of wearable sensors to a second biomechanical processing configuration, wherein the second biomechanical processing configuration is based in part on the configuration option;
at the second set of wearable sensors, collecting kinematic sensor data and applying a second biomechanical processing configuration to convert the kinematic data into a set of biomechanical signals; and
analyzing usage data from the first set of wearable sensors and the second set of wearable sensors.

17. The method of claim 16, wherein analyzing usage data comprises selecting a preferred configuration option from the first and second set of wearable sensors based on the analyzed usage data; and delivering the preferred configuration option to a third set of wearable sensors.

18. The method of claim 15, wherein the set of wearable sensors is one wearable sensor; and further comprising synchronizing a first user application on a personal computing device to the one wearable sensor; and wherein selecting the first configuration option is in response and based on synchronizing the first user application to the one wearable sensor.

19. The method of claim 18, further comprising synchronizing a second user application to the wearable sensor; selecting a second configuration option for the wearable sensor; delivering the second configuration option to the wearable sensor; and monitoring biomechanical signals at the wearable sensor according to a second biomechanical processing configuration that is set according to the second configuration option.

20. The method of claim 15, wherein delivering the configuration option comprises transmitting the configuration option from a cloud data platform to a user application and streaming the configuration option over Bluetooth low energy channel from the user application to the wearable sensor.
